(19) United States
(12) Patent Application Publication
(10) Pub. No.: US 2016/0182627 A1
(43) Pub. Date: Jun. 23, 2016

(54) APPLICATION HIBERNATION

(71) Applicant: Apollo Education Group, Inc., Pheonix, AZ (US)

(72) Inventors: Shridhar Navanageri, Cupertino, CA (US); Anil Maipady, San Jose, CA (US); Sudhakar Subashchandrabose, San Jose, CA (US); Raghavendra Reddy Mooram, Sunnyvale, CA (US); Narender Vattikonda, San Jose, CA (US)

(21) Appl. No.: 14/607,969

(22) Filed: Jan. 28, 2015

Related U.S. Application Data
(60) Provisional application No. 62/093,653, filed on Dec. 18, 2014.

(51) Int. Cl. H04L 29/08

(52) U.S. Cl. CPC H04L 67/1095; H04L 67/148; H04L 67/141; H04L 67/306

(57) ABSTRACT

A method and apparatus for capturing events in a first application on a first device and replaying the events in a second application on a second device is provided. In an embodiment, a capture unit records all actions that occur within a first application on a first device and save them as event records. The capture unit sends the event records to an application sync service which labels the events as a session and performs analytics on the records within. After receiving a request to resume the application on a second device, the application sync service sends the event records to a playback unit executing on the second device. First playback unit then executes the events in an application on the second device.

### CROSS-REFERENCE TO RELATED APPLICATIONS; BENEFIT CLAIM

This application claims the benefit of Provisional Application 62/093,653, filed Dec. 18, 2014, the entire contents of which is hereby incorporated by reference as if fully set forth herein, under 35 U.S.C. §119(e).

### FIELD OF THE INVENTION

The present invention relates to application monitoring on computer systems.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

An application that does not maintain a user's state between sessions will typically lose the user's position within the application upon termination of the application. To combat this issue, some applications store state information, allowing a user to reopen the application on the same device and pick up where the user left off.

While saving state information allows a user to restart the application at the same position, state information is usually only saved on the initial device. Some applications allow state information to be carried over to other instances of the same application on a different device. Thus, a user of a specific application may continue using the application at the same point on a separate device.

The methods described above only work if the application opened on the second device is the same as the first device because the state information is application specific. Thus, a user may not use a comparable application to resume the user's session. For example, a user may have a different browser on the user's home computer than on the user's mobile device. The difference in browser would keep the user from being able to resume a session from the home computer on the mobile device.

Another issue with the above described methods is that only the state information is saved. While a user may pick up where the user left off, the user is unable to view prior actions taken within the application.

### BRIEF DESCRIPTION OF THE DRAWINGS

In the drawings:

FIG. 1 illustrates an example network upon which embodiments may be implemented;

FIG. 2 illustrates an implementation of the capture unit on a first client device;

FIG. 3 illustrates an example user interface for displaying a list of timestamps with corresponding events;

FIG. 4 illustrates an example diagram for replaying events originally executed on a first client device on a client device 130 with different capabilities;

FIG. 5 illustrates an example user interface for replaying recorded events;

FIG. 6 is an example embodiment of an analytics tool that may be made available to a specific user;

FIG. 7 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for capturing events in an application and replaying them in a different application on a separate device. According to one embodiment described herein, an application sync manager runs a capture unit on a first device to record actions or events taken within a monitored application. The application sync manager sends the recorded actions or events to an application sync service. An application sync manager running on a second device requests to resume the prior session. The application sync manager sends the recorded actions or events to the application sync manager executing on the second device. The application sync manager on the second device then replays the events through a playback unit on a playback application.

Structural Overview

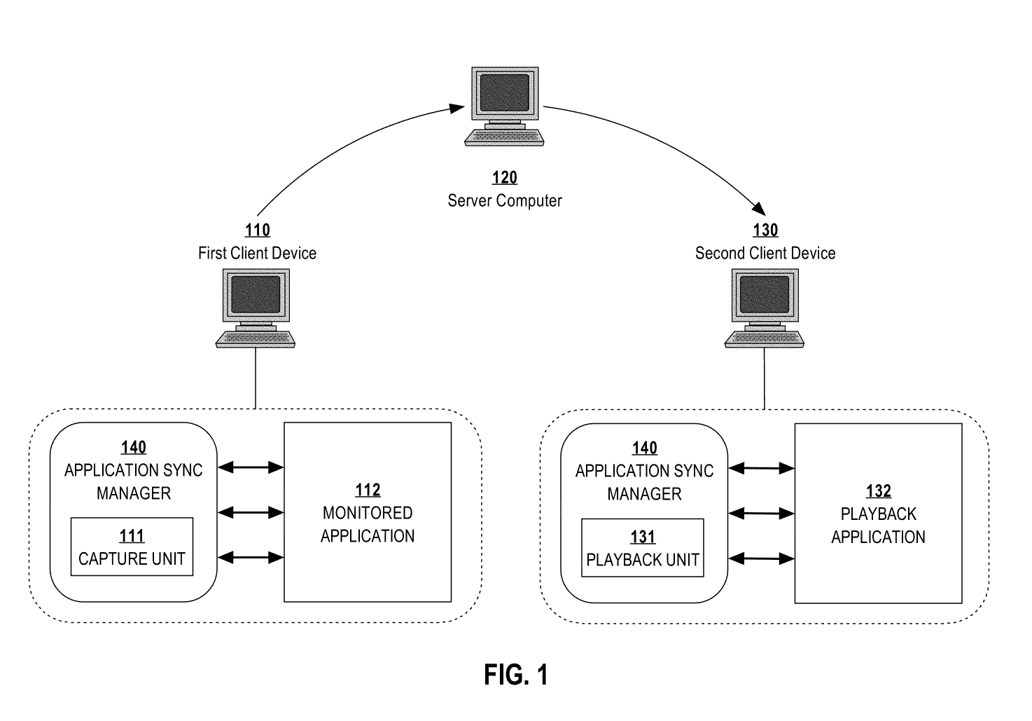

FIG. 1 illustrates an example network configured to transfer application state from one application to another, where the applications reside on different devices. Referring to FIG. 1, client device 110 is communicatively coupled to server computer 120 across a network. Server computer 120 is communicatively coupled to client device 130 over a network. In various embodiments, client device 110 and client device 130 are smartphones, tablets, computers, portable computing device, or personal computers. FIG. 1 illustrates client device 110 and client device 130 as personal computers but, in practice, embodiments can be implemented using any number of devices, include different devices for client device 110 and client device 130.

In one embodiment, an application sync manager that includes both a capture unit and a playback unit is installed on both client device 110 and client device 130. In alternative embodiments, client device 110 only has capture unit 111 unit installed, client device 130 only has playback unit 131 installed, or client device 110 only has the capture unit 111 installed and client device 130 only has playback unit 131 installed. Capture unit 111 executes on client device 110 and interacts with monitored application 112. Monitored application 112 is a computer program application executed on client device 110. Playback unit 131 executes on client device 130 and interacts with playback application 132. Playback application 132 is a computer program application executed on client device 130.

In an embodiment, the capture unit of the application sync manager acts as a layer or framework mechanism which tracks user actions in different applications using the methods described below. In other embodiments, the capture unit acts as a plug-in to an existing application such as a browser and tracks user actions in the existing application using the methods described below. In further embodiments, the application sync manager contains other interactive elements or hooks that allow a user to customize the way in which the capture unit records user actions.

### Functional Overview

The following functional description requires no particular hardware, operating system, software system, or other detail for implementation.

According to an embodiment, capture unit 111 records actions taken in monitored application 112. Capture unit 111 sends the recorded actions to server computer 120. Server computer 120 analyzes the actions and creates playback data based on the actions. Client device 130 requests to resume the prior recorded session. Server computer 120 sends the playback data to client device 130. Playback unit 131 replays in playback application 132 the actions originally taken in monitored application 112.

### Capturing State of a Monitored Application

In an embodiment, the application sync manager requires a user to sign in to a user account before executing the capture unit. In some embodiments, the user account is associated with identification information of the user. For example, a user account is associated with a user's name, geographic location, preferences, group information, or connections to other users. The user account comprises one or more roles which grant the user specific privileges, such as access to other user records or sessions.

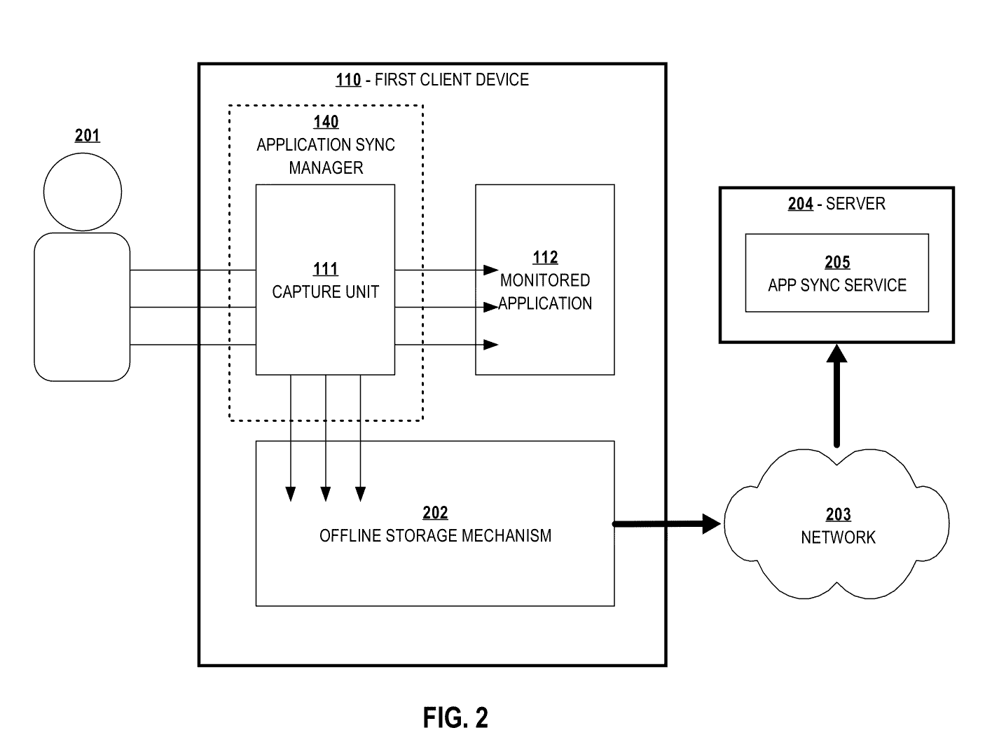

FIG. 2 illustrates an implementation of the capture unit 111 on first client device 110. As a first user 201 executes actions within a monitored application 112, the monitored application 112 exposes those actions through the document object module (DOM) layer. Actions, or events, that are exposed through the DOM layer may include page sequencing, URLs, network calls, and user initiated actions such as selecting, scrolling, or typing. A capture unit 111 intercepts information exposed by monitored application 112 through the application programming interface (API) of monitored application 112. In some embodiments, the information saved by capture unit 111 includes user initiated actions such as clicking, typing, or selecting. In other embodiments, state information made available through the APIs of monitored application 112 is saved as well. In an embodiment, the capture unit 111 also accesses notifications made through the APIs of monitored application 112 which specify a change in monitored application 112, such as browser history.

The capture unit 111 also intercepts metadata along with specific events. The metadata associated with the events are used to categorize the events. According to one embodiment, metadata captured by capture unit 111 includes user identification, timestamps for each event, monitored application details, and the context of each event.

In an embodiment, capture unit 111 records events at the highest possible granularity. For example, capture unit 111 records every mouse click, highlight, or scroll that occurs within an application. By recording events at such a high granularity, capture unit 111 can create a complete record of a user's interactions with a specific application.

In an embodiment, capture unit 111 records events occurring in monitored application 112 while first client device 110 is not in communication with server 204. First client device 110 may initially not be in communication with server 204 because the first user has chosen to not sign in or because the first client device is not connected to the Internet. In this embodiment, the capture device still records actions taken by the first user in monitored application 112. The records are then stored in offline storage mechanism 202 until first client device 110 begins communicating with server 204. Once a connection has been established between first client device 110 and server 204, application sync manager 140 sends the records to server 204.

While FIG. 2 only illustrates a single monitored application, in an alternative embodiment capture unit 111 monitors multiple applications at the same time. In an embodiment, each application is assigned a specific namespace. Actions taken within each application are recorded along with the namespace of the application. This allows playback unit 131 to recognize actions specific to each application and only replay those actions in the correct application.

### Offline Storage of Captured Actions

In an embodiment, every action taken within an application is recorded. In some embodiments, the actions are saved to offline storage mechanism 202 instead of being sent to application sync service 205 individually. Offline storage mechanism 202 generally represents storage associated with first client device 110, storage associated with monitored application 112, and/or storage associated with application sync manager 140.

### Sending Stored Actions to the Sync Service

When captured actions have been stored offline, application sync manager 140 applies one or more rules to determine when to send the batched event records to application sync service 205 through network 203. In one embodiment, application sync manager 140 waits for a send-triggering event to occur before sending the batched records to the application sync service 205. The send-triggering event may vary from implementation to implementation, and may include, for example:
application sync manager 140 recording a set number of actions,
application sync manager 140 receiving an indication that the monitored application has been closed, or
application sync manager 140 receiving an indication that the user session has ended.

In another embodiment, application sync manager 140 measures the amount of storage being used by the event records or the amount of storage remaining. If either measure surpasses a pre-set limit, application sync manager 140 sends the batched event records to application sync service 205. In some embodiments, certain actions are flagged as important. When application sync manager 140 determines that one or more flagged actions have been recorded, application sync manager 140 then transmits the event records to application sync service 205.

In one embodiment, the application sync manager operates in a manner to minimize the performance reduction that results from running application sync manager 140 on the client device. For example, in one embodiment, as a user executes an action, application sync manager 140 is restricted to writing the action to a record. The application sync manager 140 waits until the user is idle before sending records of the actions to application sync service 205. In other embodiments, application sync manager 140 waits to send records of actions until it can determine that sending the records of actions to application sync service 205 would cause a minimal burden on client device 110.

### Analyzing and Categorizing User Events

Once application sync service 205 receives the event records from application sync manager 140 running on the first client device, application sync service 205 stores the records or analyzes the records before storing them. Application sync service 205 initially associates one or more session identifiers with the event records. Thereinafter, application sync service 205 refers to those events as a session with a specific session identifier. Application sync service 205 also categorizes individual actions based on contextual information (e.g. location on a webpage) and one or more timestamps associated with the actions. Application sync service 205 then saves that user session in a format that keeps the basic data analysis.

According to one embodiment, user 201 signs in to a user account before executing capture unit 111. Capture unit 111 then captures event records that reflect the interaction of user 201 with monitored application 112. Those captures event records are eventually sent from client device 110 to Application sync service 205. Upon receiving those event records, application sync service 205 relates the event records to information associated with the user account of user 201. By relating event record to stored user information, application sync service 205 obtains more information with which to analyze the event records. According to one embodiment, application sync service 205 analyzes the event records with respect to stored metadata associated with the user identification to create playback data. For example, in one embodiment, application sync service 205 cross-references the websites visited by the user 201 in the most recent session with websites visited by the user 201 in prior sessions. As another example, application sync service 205 categorizes the sessions by specific important actions taken in those sessions, such as completing one or more assignments.

According to one embodiment, application sync service 205 assigns different priorities to actions recorded in the event records. For example, in one embodiment, application sync service assigns a high priority to events that involve navigation from one web page to another while assigning a lower priority to events such as highlighting or scrolling events. In one embodiment, these priorities are set ahead of time by one or more users or administrators.

In some embodiments, application sync service 205 uses a dictionary of events to relate specific events to specific priorities. Such a dictionary establishes a mapping between event types and event categories and/or priorities. As an example, the dictionary of events categorizes an event type, such as navigating to a different page, to high priority. Conversely, the dictionary of events categorizes the event type “movement of the cursor” to low priority. When an event qualifies as an event type that is listed in the dictionary, the event priority to which the event type is mapped is then stored as part of or in association with the event record for the event.

### Translating Events

In some embodiments, the dictionary of events also contains translations of events for different applications. Events are often described in different ways by different applications. A first browser may describe a selection event as select/x while a second browser describes the same event as x/select. When application sync service 205 receives the record of events, the application server first accesses the dictionary of events to categorize events that occurred in the monitored application. The dictionary of events includes types of events categorized by application. In the above example, application sync service 205 accesses the dictionary of events and searches for the first browser. Upon finding the first browser, application sync service 205 searches through events as described by the first browser for select/x. Select/x is listed in the dictionary of events as a selection event. Application sync service 205 would then categorize the event as a selection event.

In some embodiments, application sync service 205 translates the events into an application-independent event. Application sync service 205 then retranslates the events into application-specific events based on the application that is attempting to replay the events that are recorded in the event records. In the above example, application sync service 205 would create a new record of events that correspond to the original events. Application sync service 205 translates every select/x event into ‘selection event.’ When application sync service 205 later determines which application to use as the playback application, application sync service 205 translates the events from application-independent events (e.g. selection event) to application-specific events (e.g. x/select).

### Analyzing User Sessions

In an embodiment, application sync service 205 analyzes user sessions as a whole. Application sync service 205 compares aggregate data, such as number of events and time spent on events, among multiple user sessions. For instance, as part of performing the analysis, application sync service 205 determines where a first user session diverged from a related user session. For example, two user sessions include accessing the same puzzle. Application sync service 205 creates a record at the point where one user performed a different action with respect to the puzzle than the other. Other comparison analytics include comparing time spent on specific modules or actions taken to complete specific modules.

In some embodiments, application sync service 205 analyzes the sessions with respect to prior sessions of the same user, scores related to the accessed modules, or user specific information such as geographic location or user preferences. In the puzzle example discussed above, application sync service 205 determines a correlation between the amounts of time spent on different modules within the puzzle to the scores received on the modules. Alternatively, application sync service relates time spent on the entire puzzle to the time spent by the same user on previous puzzles of similar difficulty.

### Event Logs

In an embodiment, application sync service 205 creates a log of events with their associated timestamps. The event logs contain the timestamps of each event listed in chronological order as rows with a column for the events. In further embodiments, the event logs contain additional columns for priority information associated with the corresponding event and the amount of time between the current event and either a prior event or next event. Another embodiment includes a description column in the event logs which creates an overall description of multiple events, such as “Puzzle A” for all events that occurred after initiating Puzzle A and before completing Puzzle A.

In an embodiment, application sync service 205 displays the event logs to a user. In some embodiments, only events with a specific priority are listed in the event logs. In other embodiments, certain events are made visually distinguishable in the event logs from other events based on one or more factors, including the priority of events.

In an embodiment, application sync service includes more complex data within the event logs, such as descriptions that encompass multiple events. As an example, a first recorded event is initializing an examination while a later recorded event is submitting the examination. The event logs contain a description of the period of time between the two events as “exam data.”

### Presenting Prior Sessions for Resumption

Once the event records of a user session have been recorded, the user session can be “resumed” by replaying actions based on the event records. In an embodiment, the user 201 whose session on client device 110 signs into a user account using client device 130. Upon receiving an indication that the user signed in on client device 130, application sync service 205 identifies the user profile. Application sync service 205 determines that a session is available to be resumed by the user. Application sync service 205 then displays the option for the user to continue the previous session.

In some embodiments application sync service presents the user of the client device 130 with a list of saved user sessions. The saved user sessions include sessions originally linked to the user's profile, or sessions shared with the user by other users. In an embodiment, application sync service 205 detects the last session executed by the user and presents the user with the option to resume the prior session. The user chooses to resume the prior session, start a new session while retaining the prior session's records, or remove the prior session. In some embodiments, removing the prior session only causes the application sync manager 140 to cease displaying the session to the user for resumption. Application sync service 205 still stores the event records of the prior session for analytics or resumption by a different user.

In some embodiments, in addition to displaying a list of saved user sessions, the display presented to the user includes, for each session, a list of the events that occurred within the session. For example, a first user opens a tab in a browser, navigates to a specific URL, scrolls down the page, and clicks a link. Capture unit 111 saves these actions and either categorizes the actions before sending them to application sync service 205 or sends the actions to application sync service 205 for categorization and storage. The categorizations of each action are displayed under the specific session ID. Thus, a user of client device 130 sees that in a specific session a tab was opened in a browser, the browser navigated to a specific URL, the scroll feature was accessed on the page, and a link was selected. This information helps a user determine which session to access because it describes each session by more than just the date.

### Resuming Prior Sessions

Upon receiving a request from client device 130 to resume a specific user session, the application sync service 205 sends “playback data” for that session to the application sync manager executing on the client device 130. Playback unit 131 then replays the events from the playback data in playback application 132. In an embodiment, playback unit 131 executes each event in playback application 132 through the APIs of playback application 132 as if playback unit 131 was a user. For example, if a user of monitored application 112 initially selected a link for a test question, typed in an answer, and selected the submit button, playback unit 131 would send the same instructions to playback application 132, causing playback application 132 to select the link, enter the same data into the text field, and select the submit button.

By replaying the events, playback unit 131 allows a specific state of the previous session to be restored while keeping intact the history of the actions in the playback application 132. In an embodiment, playback unit 131 replays the events in the playback application 132 without making the replay visible to the user operating the client device 130. The user only sees the playback application 132 at the same end state as the monitored application 112, but with the history still intact, allowing the user to undo specific actions or navigate through the history using the controls of the playback application. For example, in the case of a browser, a user selects the “back” button to navigate to a prior page accessed in the original user session. As another example, a user initiates an “undo” action to navigate to a prior state of the playback application 132 as that prior state existed in the original session.

### Snapshots of Application State

In an embodiment, capture unit 111 allows a user to take snapshots of the monitored application 112. A snapshot reflects the state of monitored application 112 at a given time. In some embodiments, a graphical user interface includes a snapshot button that the user selects to take a snapshot. In other embodiments, application sync manager 140 contains specific protocols for taking a snapshot in response to specific user input. For example, by holding down Ctrl and pressing the spacebar, a user initiates a take-snapshot action. The act of taking a snapshot saves the state information of the application. In another embodiment, the act of taking a snapshot inserts a marker into the event records that indicates the occurrence of a take-snapshot event. This information is used later by playback unit 131 to resume a session at a given point.

Playback unit 131 allows a user to resume a session at a specific point within the session. In some embodiments, playback unit 131 displays to the user the event logs of the events when the user selects a specific session to resume. The event logs also include one or more snapshot events created by the user of the first client device. In some embodiments, the snapshot events are made visually distinguishable from other events in the event logs. According to one embodiment, playback unit 131 includes a mechanism that allows the user selects a specific event in the list. Upon receiving the selection from the user of an event at which to resume, playback unit 131 executes all events that occurred before the selected position. In the case of the snapshots, playback unit 131 executes all events that occurred before the selected snapshot event.

### Resuming in Different Applications

In an embodiment, playback application 132 is a different application than monitored application 112. In some embodiments, capture unit 111 monitors the actual events executed by the user, such as clicking, typing, and navigation, so that playback unit 131 can replay the stored event records on a different application. For example, if a user navigates to a specific web page on one brand of browser, scrolls down to the middle of the page, and clicks on a link, the event records would comprise navigating to a specific web page, executing a scrolling action, and selecting a link on the web page. Thus, the same actions could be played back in a different brand of browser to perform the same functions.

In some embodiments, the request sent from client device 130 to application sync service 205 to resume a specific session is accompanied by information as to the identity of the playback application 132 to be used on the client device 130. Application sync service 205 uses the dictionary of events to translate the event records within the playback data from events as described by monitored application 112 into events that can be read by playback application 132. For example, if monitored application 112 has a specific way of describing a selection event (e.g. x/select) and playback application 132 has a different way of describing a selection event (e.g. select/x), application sync service 205 would access the dictionary of events to create a set of records in the format used by playback application 132 (e.g. changing x/select into select/x).

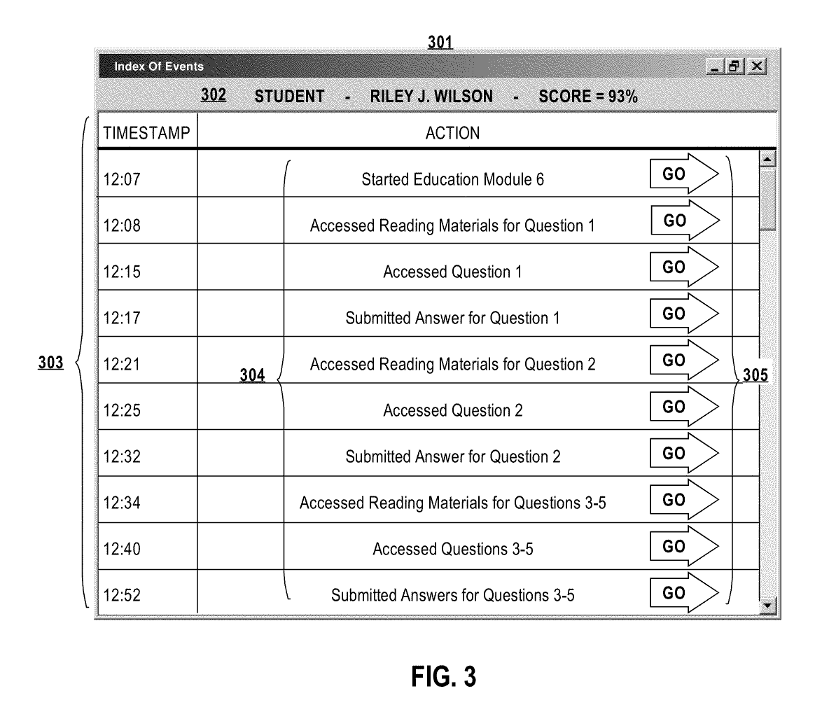

FIG. 3 illustrates an example user interface that includes a list window 301 that displays a chronological list of events that were recorded from a previously-captured session. List window 301 includes user metadata header 302, timestamps 303, event descriptions 304, and selection buttons 305. A user initiates playback up to a specific event by selecting the selection button corresponding to the specific event.

In some situations, the client device 110 is the same as the client device 130. That is, the same device that a session was captured on is the device on which the session is restored. In some embodiments, playback application 132 does not need to replay all of the events from the user session. Instead, playback application 132 just refreshes the local storage on the first client device. Saved state information allows the user to resume the previous session based on the local storage with all of the user's history intact.

### Capturing Identifying Information

In some situations, actions taken by the first user in the monitored application include entering identifying information into a specific field, such as a username and password. In an embodiment, capture unit 111 gives the user the option when the user starts a session to request that identifying information entries be stored by capture unit 111. In other embodiments, capture unit 111 displays an alert to the user that the user entered identifying information and prompts the user to either allow the capture device to capture the entry of the identifying information or to skip the entry event and begin recording at the next event.

In an embodiment, storing identifying information entries as events includes encrypting the identifying information such that it is available for replaying the events but not visible to a second user. In some embodiments, capture unit 111 only records events before and after the entry of identifying information, either by default or by user request. When a user requests to a resume a session on client device 130, playback unit 131 replays only the events before the entry of identifying information. Playback unit 131 prompts the user of client device 130 to input the identifying information before proceeding. Upon receiving an indication from either the user or playback application 132 that the user has entered the identifying information into playback application 132, playback unit 131 replays all stored events that occurred in the first session after the entry of identifying information.

### Devices With Different Capabilities

In some situations, client device 130 has different capabilities than first client device 110. For example, first client device 110 is a desktop while client device 130 is a tablet or smartphone. When the client devices have different capabilities, application sync service 205 translates events from the recorded user session into events that can be executed on client device 130.

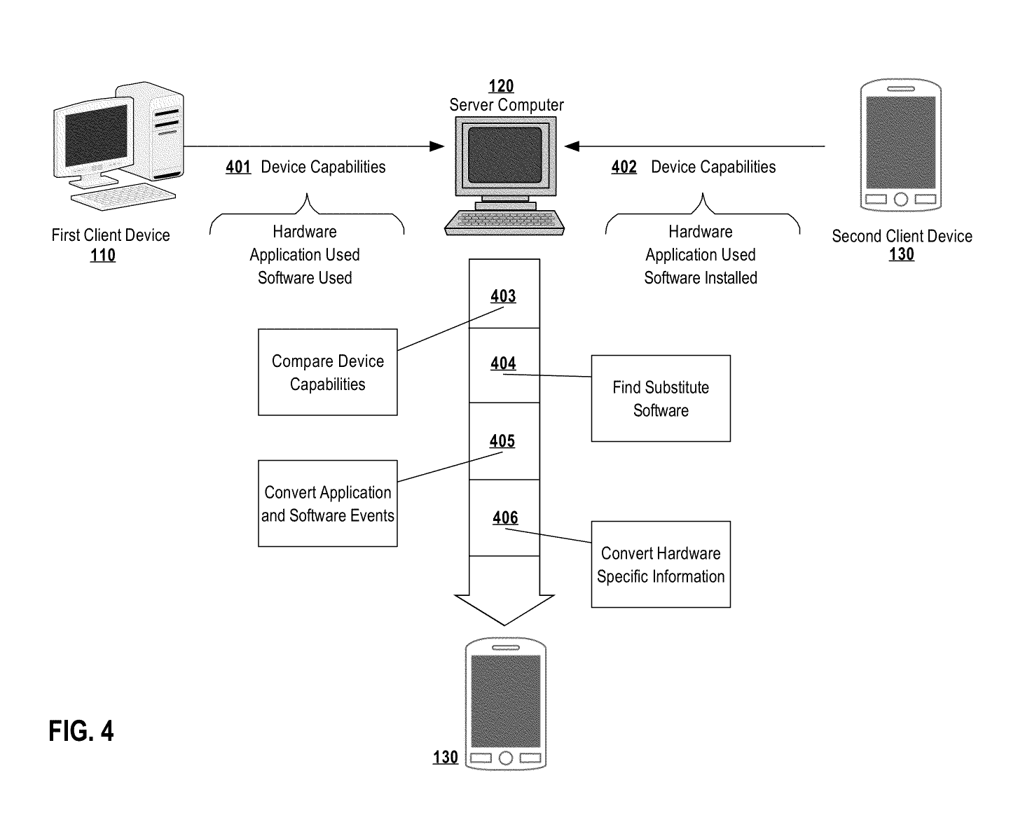

FIG. 4 illustrates an example diagram for replaying events originally executed on a first client device on a client device 130 with different capabilities. First client device 110 has first device capabilities 401. Client device 130 has second device capabilities 402. Server computer 120 initially receives first device capabilities 401 from first client device 110 along with the records of the first events. When client device 130 sends the request to resume the initial user session, client device 130 also sends second device capabilities 402 to server computer 120.

At block 403, application sync service 205 executing on server computer 120 compares first device capabilities 401 with second device capabilities 402. Upon determining that the devices have different capabilities, application sync service 205 proceeds to translate the records of first events into translated event records that can be executed on client device 130.

At block 404, server computer 120 finds substitute software on client device 130 for playing events in playback application 132. In some scenarios, first client device 110 has specific software installed which is not available on client device 130. If application sync service 205 determines that client device 130 is missing software used on first client device 110, application sync service 205 accesses the dictionary of events which describes substitute applications for playing certain events. For example, if an event involved executing a specific media player, the dictionary of events defines different comparable media players that are capable of acting as substitutes. Application sync service 205 checks the software installed on client device 130 for any substitute applications defined by the dictionary of events.

At block 405, in an embodiment, application sync service 205 determines how to convert application and software events into translated event records. The specific algorithm used by application sync service 205 involves accessing the dictionary of events and, for each event, determining what event took place, how the event was performed, and how a similar event would be performed on client device 130.

In some embodiments, the difference between first device capabilities 401 and second device capabilities 402 requires the playback unit 131 to perform events in a different way on client device 130 than they were performed on first client device 110. As an example, one event that occurred within the first user session is an asynchronous JavaScript and XML (AJAX) call to a server. A standard browser on first client device 401 has eight open channels and thus is able to make eight concurrent calls. In contrast, client device 130 403 has only two open channels and thus is only be able to make two concurrent calls. In this situation, server computer 120 converts the event records into a slower format where only two concurrent calls are made.

At block 406, hardware-specific events are translated for use by playback unit 131. Hardware-specific information includes memory, graphics, screen resolution, and screen size. For example, first client device 110 as shown in FIG. 4 has a screen with a specific size and resolution while client device 130 has a screen with a smaller size and resolution. If a user moves a cursor to a point on the page on the first client device, that event is initially described in terms of a pixel coordinate on the screen. Application sync service 205 translates the pixel coordinates to percentages of the screen to create hardware independent events. After receiving the request from client device 130 to replay the events, application sync service 205 translates the percentages of the screen into pixel coordinates on client device 130. In this way, hardware specific information (pixel coordinates) is translated into hardware independent information (percentages of a screen) and then back into hardware specific information (new pixel coordinates). In some embodiments, application sync service 205 just translates the hardware specific information from one device to another device. In the pixel example, application sync service 205 uses the ratio between the two screen sizes to determine the pixel coordinates on client device 130.

### Troubleshooting

In some embodiments, application sync manager 140 is used to troubleshoot a specific problem. For example, a user receives an error when using a specific application. The user chooses to run capture unit 111 on the user's device while using the specific application. Upon receiving the error, the user ends the user session. The user then contacts a specialist to determine the source of the error. The specialist requests that the user provide the specialist with access to the user session that included the specific error.

In some embodiments, the user alters access controls associated with the user session to allow application sync service 205 to send playback data of the user session to the specialist's device. In another embodiment, the user directly sends the user session data along with the device capabilities of the user's device to the specialist. The specialist then uses the playback data to impersonate the user's device based on the device capabilities of the user's device. While impersonating the user's device, the specialist replays the actions of the user through the user session data in order to recreate the error. In an embodiment, the specialist navigates through different events to determine which events caused the error. In other embodiments, the specialist uses the device capabilities of the user's device to determine the cause of the error. For example, while impersonating the user's computer, the specialist may run diagnostics on an application to determine if it was installed correctly.

In some embodiments, the specialist uses the snapshots taken by the user to troubleshoot a specific problem. For example, the specialist may tell a user to initiate a take-snapshot action when the user opens the application and during different points within the application. When replaying the application through playback unit 131, the specialist navigates to specific snapshots to determine the source of the problem.

### Replaying Events

In an embodiment, a user requests to replay the events of a previously-captured session in real time. Playback unit 131 uses the saved timestamps to replay the events in the application at the same speed as they originally occurred. In some embodiments, the user is given access to a playback interface that allows the user to customize playback of events.

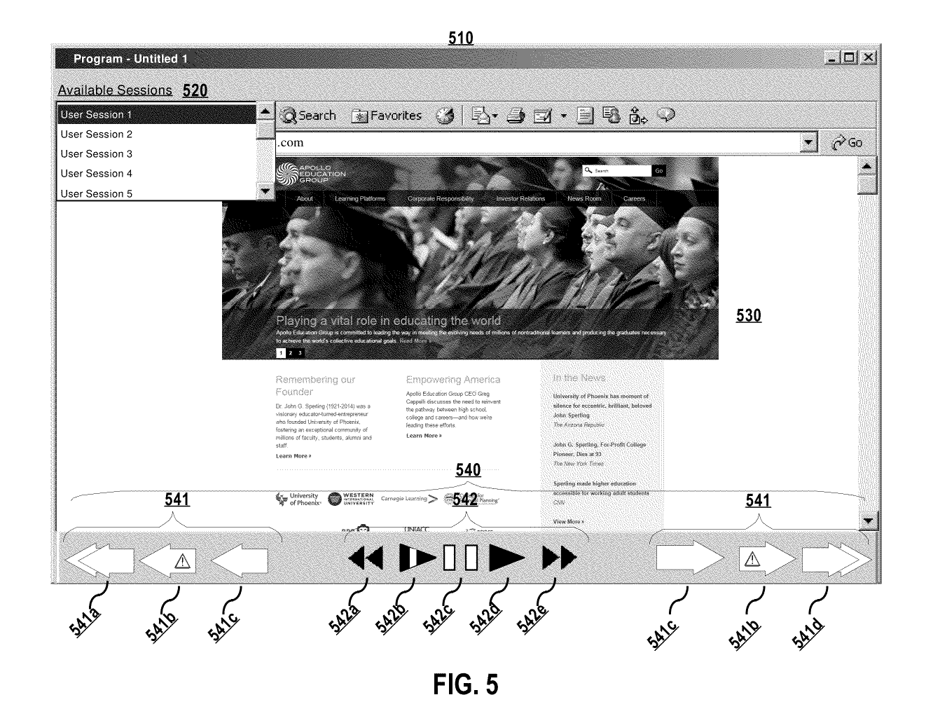

FIG. 5 illustrates an example user interface for replaying recorded events. Application window 510 includes session selection drop down menu 520, playback application interface 530, and playback controls 540. Playback controls include step through controls 541 and replay controls 542. Replay controls 542 allow a user to replay recorded events in real time. Pause button 542c allows the user to stop the playback at a given point. Resume button 542d causes the events to being playing in real time. Fast forward button 542e alters the speed of the playback by decreasing the amount of time between timestamps proportionally. Conversely, slow button 542b alters the speed of playback by increasing the amount of time between timestamps proportionally. Reverse button 542a alters the replay to play events backwards. In some embodiments, successive presses of reverse button 542a increases the speed at which events are played backwards.

While FIG. 5 shows a single window, some embodiments allow multiple sessions to be played back at the same time. For example, in some scenarios a user will wish to compare the differences between two sessions. Instead of just showing the timestamps of events, playback unit 131 is configured to replay two sessions in separate windows.

In an embodiment, a user is given the option of replaying events individually. Playback unit 131 provides a user interface such as the one shown in FIG. 5 to replay events individually. Step through controls 541 allow a user to navigate through events without requiring the user to watch the events unfold in real or altered time. First button 541a navigates the user to the first event in the session while last button 541d navigates the user to the last even in the session. Individual event buttons 541c allow a user to navigate forward and backwards through each individual event. In an embodiment, priority buttons 541b allow a user to navigate forwards and backwards through events that have been marked as priority events. Upon selecting one of priority buttons 541b, playback unit 131 executes all events that occurred between the current timestamp and the next priority timestamp.

In some embodiments, individual event buttons 541c act similarly to priority buttons 541b in that they only navigate through certain types of events. For example, individual event buttons 541c navigate from one type of action to the next. Thus, if a user entered text into an editable text box in a browser, individual event buttons 541c navigate between an empty text box to a completed text box without including each individual interim text entry. In alternate embodiments, individual event buttons follow more complex rules to determine which events to navigate to. Thus, if a user enters a large amount of text into a text box, individual event buttons 541c navigate to a point in the text entry based on a number of characters typed, an amount of time spent typing, or specific text entry actions such as carriage returns or deletions.

In an embodiment, users limit which events are considered priority events for the purpose of navigation using playback unit 131. As an example, a user sets priority buttons 541b to navigate to timestamps where the first user executed a snapshot. Thus, the first user determines points at which playback unit 131 stops playback when the second user selects priority buttons 541b.

In some embodiments, the user of first client device 110 chooses specific people, groups, or institution with which to share the user sessions. In alternate embodiments, the user makes the decision to share the user sessions either before beginning the user session or after saving the user session. Whenever a particular user signs into the application sync manager, the particular user is provided with a list of sessions to resume, which include both sessions created by the particular user and sessions shared with that particular user. The user interface illustrated in FIG. 5 includes an example of this list through session selection drop down menu 520. Session selection drop down menu 520 allows a user to switch between sessions to resume. In other embodiments, playback unit 131 gives the user the list of sessions to resume initially and the user must exit the originally selected session before entering a second session.

### Teaching Methods

In an embodiment, a learning institution utilizes application resumption to increase the proficiency of the students and faculty. For example, a teacher working on evaluating, grading, providing feedback, editing syllabi, or performing syllabi can close all open programs before the teacher enters a classroom. After finishing the class, the teacher can resume where the teacher left off on the same or different device. In addition, if the teacher sends a notification to a student on one device, the notification would be replicated across all devices accessed by the student.

In an embodiment, a teacher utilizes application resumption to create a step-through model for students. Initially, the teacher performs specific steps in a monitored application on the teacher's device. The teacher then shares the user session with the students. In one embodiment, the teacher also annotates each step with additional information. For example, the teacher may include an annotation during an event where the teacher inputs ‘/s’ into a search field that says “it's best to use ‘/s’ for the search terms in this case because we are not sure the words appear next to each other but we know the words must appear in the same sentence.” When a student receives the session, the user is able to replay the events at the student's own speed.

In embodiments, students utilize application resumption to create a step-through model for their teachers. For example, a student who repeatedly receives the wrong answer on a specific question may decide to ask the teacher for help. The student creates a user session and performs all of the steps that lead the student to the wrong answer. The student then shares the session with the teacher. The teacher then uses step through controls to determine where the student erred.

In an embodiment, a learning institution utilizes user session data to improve teaching methods. In one scenario, a learning institution wishes to track the actions of a student who appears to do well on homework assignments and tests. The learning institution determines, using the stored session data, that the successful student performed a specific set of actions before achieving a high score on an examination. The learning institution is then able to recommend those actions to other students who wish to succeed or modify future questions to encourage students to follow similar methods. Additionally, the learning institution can use the best path traversed by a successful student to modify future lessons so that they focus on those points.

In another scenario, a learning institution shares the user session of the successful student with the rest of the class. A first student who performed poorly is able to view the session of the successful student to determine how to reach the correct answer. For tests that contain multiple dependent parts, the first student can resume the successful student's session following the first student's initial error. Using this method, the first student can demonstrate knowledge in the remainder of the test regardless of the initial errors. In another embodiment, the teacher shares the user session of an unsuccessful student with a class to point out common mistakes.

In an embodiment, certain information is hidden from a user who is replaying a shared user session. For example, a teacher wishes to share the student session of the most successful student with the rest of the class. While the teacher has access to the name of the successful student when viewing the session, the session is anonymized when viewed by fellow classmates. The amount of information available to a user is thus based on one or more roles associated with a user profile. In the above example, the teacher is assigned a role with a higher level of information than a student. In addition, a first user is able to determine the amount of information available to another user who wishes to access the first user session.

In some embodiments, application sync manager 140 runs on the teacher's device when the teacher is reviewing assignments. The teacher can select a student session while reviewing the score the student received on an assignment. Application sync manager 140 replays the events in that session, allowing the teacher to better understand how the student received the specific score. The teacher can speed up or slow down the replay to skip to sections of the session where the student began making mistakes.

In an embodiment, application sync service 205 analyzes session information for a plurality of users. The analysis includes determining the amount of time between specific actions for each user. Application sync service 205 correlates the amount of time between the specific actions with one or more results. For example, a teacher wishes to track how long each student spent on an individual problem on an examination. The teacher also wants to know if the amount of time spent on a specific problem correlated to a different result. As a more complicated example, a teacher wishes to correlate the amount of time spent on one or more homework assignments with a score on a specific examination. In these cases, application sync service 205 calculates the amount of time spent on homework problems or specific test questions by using timestamp records associated with initiating and ending sections of a session.

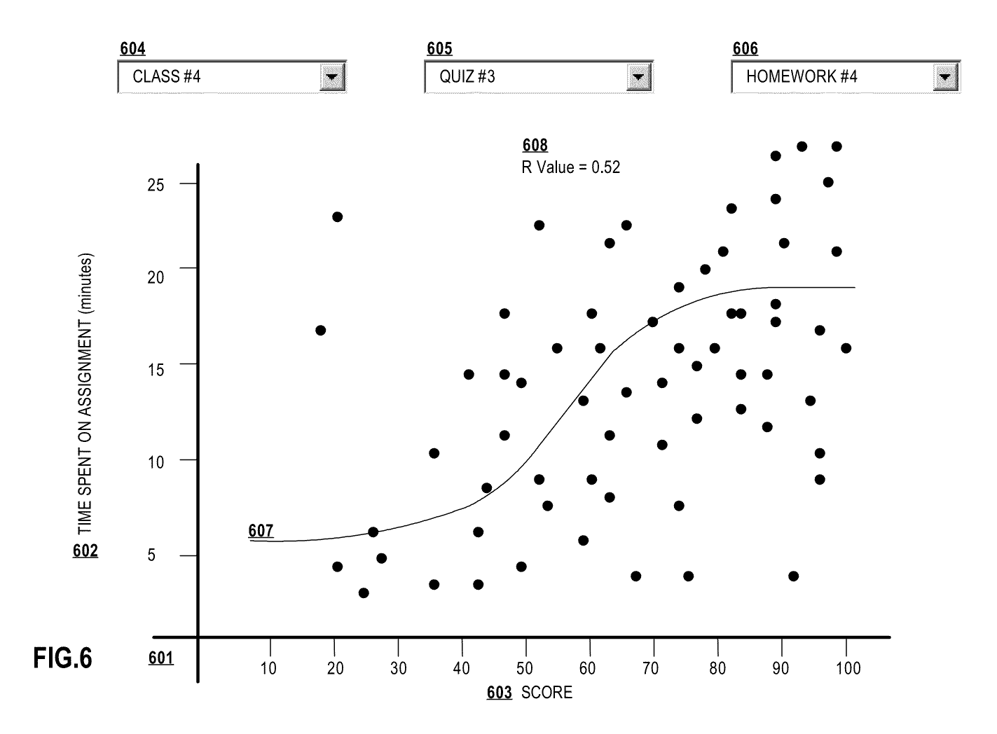

FIG. 6 is an example embodiment of an analytics tool that is made available to a specific user. Graph 601 represents a graph correlating the time spent on a specific assignment 602 with a score received on an examination 603. Drop down menus 604, 605, and 606 allow a user to specify a group on which to run the analytics, a specific examination, and a specific assignment. A user selects any of drop down menus 604, 605, and 606 to change one of the parameters. Correlation curve 607 displays a correlated relationship between the two chosen parameters. Finally, R Value 608 describes the strength of the correlation.

### Hardware Overview

According to one embodiment, the techniques described herein are implemented by one or more special-purpose computing devices. The special-purpose computing devices are hard-wired to perform the techniques, or include digital electronic devices such as one or more application-specific integrated circuits (ASICs) or field programmable gate arrays (FPGAs) that are persistently programmed to perform the techniques, or include one or more general purpose hardware processors programmed to perform the techniques pursuant to program instructions in firmware, memory, other storage, or a combination. Such special-purpose computing devices also combine custom hard-wired logic, ASICs, or FPGAs with custom programming to accomplish the techniques. The special-purpose computing devices include desktop computer systems, portable computer systems, handheld devices, networking devices or any other device that incorporates hard-wired and/or program logic to implement the techniques.

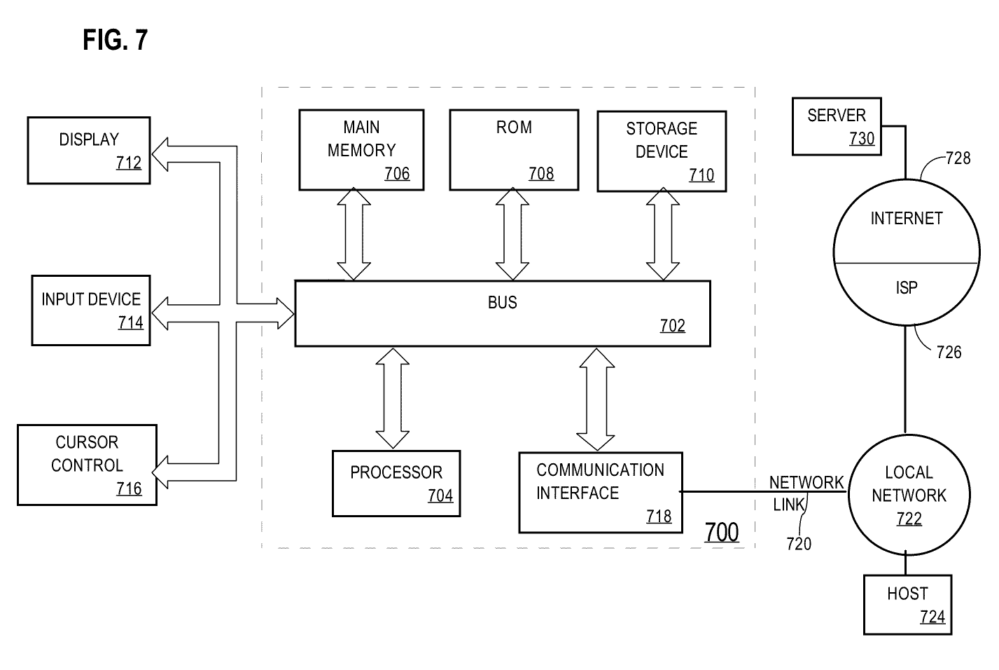

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 is, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also is used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 is coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 implements the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions are read into main memory 706 from another storage medium, such as storage device 710. Execution of the sequences of instructions contained in main memory 706 causes processor 704 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media comprised non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but id used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media are involved in carrying one or more sequences of one or more instructions to processor 704 for execution. For example, the instructions are initially carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 are optionally stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 is an integrated services digital network (ISDN) card, cable modem, satellite modem, or a modem to provide a data communication connection to a corresponding type of telephone line. As another example, communication interface 718 is a local area network (LAN) card to provide a data communication connection to a compatible LAN. Wireless links are also be implemented. In any such implementation, communication interface 718 sends and receives electrical, electromagnetic or optical signals that carry digital data streams representing various types of information.

Network link 720 typically provides data communication through one or more networks to other data devices. For example, network link 720 provides a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code is executed by processor 704 as it is received, and/or stored in storage device 710, or other non-volatile storage for later execution.

In the foregoing specification, embodiments of the invention have been described with reference to numerous specific details that vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
while a capture unit and a monitored application are executing on a first client device, capturing, by the capture unit, first events that occur in the monitored application;
wherein the capture unit is separate from the monitored application and captures the first events through an API of the monitored application;
sending, by the capture unit, records of the first events to a sync service executing on a server computer that is remote relative to the first client device;
generating, by the sync service, playback data based on the records;
sending, by the sync service, playback data to a second client device;
executing a playback unit and a playback application on the second client device;
sending, by first playback unit, to the playback application, the playback data;
wherein first playback unit is separate from the playback application and sends at least a subset of the playback data through an API of the playback application; and
wherein sending the playback data through the API of the playback application causes second events, that correspond to at least a subset of the first events, to occur in the playback application.

2. The method of claim 1 further comprising:
after capturing the first events, persistently storing the records of the first events in local storage of the first client device;
sending the records of the first events from the first client device to the sync service only after detecting occurrence of a send-triggering event, wherein the send-triggering event is one of:
receiving an indication that the local storage is full;
receiving an indication that an amount of local storage occupied by the records has exceeded a specified threshold;
receiving an indication that the monitored application has been closed;
receiving a request to close the capture unit;
receiving user input that includes a request to send the records of the first events;
receiving an indication that the first client device is online; and
receiving an indication that the capture unit has been executing for longer than a specified amount of time.

3. The method of claim 1, wherein:
the first events are events that occur in a first user session associated with a first user; and
the second client device is a device controlled by a second user that is different than the first user.

4. The method of claim 3 wherein the playback data is sent to the second client device in response to the second user selecting the first user session from a plurality of selectable user sessions.

5. The method of claim 4 further comprising:
storing connection data that indicates that the second user is connected to a plurality of other users;
wherein the plurality of other users includes the first user;
wherein the plurality of selectable user sessions includes user sessions associated with users that belong to the plurality of other users.

6. The method of claim 3 wherein the playback data is sent to the second client device based, at least in part, on the first user requesting to share the first user session with the second user.

7. The method of claim 1 wherein:
each of the first events are associated with a corresponding priority level; and
the second events include only events that have been assigned a priority level at or above a minimum priority level.

8. The method of claim 1, further comprising:
while the capture unit and the monitored application are executing on the first client device, detecting occurrence of a first take-snapshot event; and
in response to detecting the first take-snapshot event, generating a first snapshot indication that indicates a first position within the records of the first events, wherein causing the second events to occur in the playback application comprises:
causing a first portion of the first events to occur in the playback application where the first portion of the first events includes events that occurred before the first take-snapshot event in the monitored application.

9. The method of claim 8, further comprising:
while the capture unit and monitored application are executing on the first client device, detecting occurrence of a second take-snapshot event; and
in response to detecting the second take-snapshot event, generating a second snapshot indication that indicates a second position within the records;
wherein causing the second events to occur in the playback application further comprises:
receiving one or more navigation requests from the second client device to navigate to a second snapshot of the monitored application; and
causing a second portion of the first events to occur in the playback application where the second portion of the first events includes events that occurred after the first snapshot indication and before the second snapshot indication.

10. The method of claim 1 further comprising:
extracting first session information from the records of the first events;
wherein the session information includes at least one of:
timestamps for each event;
type of event;
identification of a first user associated with the first events; and
stored result information associated with the first user; and
comparing at least the first session information with information from records of related events.

11. The method of claim 1, further comprising:
extracting a timestamp for each event in the records of the first events;
creating a list of timestamps with corresponding events;
displaying, on the second client device, the list of timestamps with corresponding events;
receiving one or more inputs on the second client device that selects a specific event;
wherein the second events include only events that occurred before the specific event.

12. The method of claim 1 further comprising:
extracting first session information from the records of the first events;
wherein the first session information includes at least one of:
timestamps for each event;
type of event;
identification of a first user associated with the first events;
diagnostics of the first user computing device and;
stored result information associated with the first user; and
displaying on the second client device the first session information.

13. The method of claim 12 further comprising:
determining, one or more access levels for the records of the first events;
assigning the one or more access levels to one or users;
wherein the one or more access levels define a portion of the first session information to be made available to a user;
receiving, from the second device, prior to sending the playback data, user identification of a user operating the second client device;
determining that the user has been assigned an access level; and
displaying on the second client device only the portion the first session information defined by the assigned access level.

14. The method of claim 1 further comprising:
displaying on the client device a graphical user interface separate from the playback application for selecting and altering the second events;
wherein the graphical user interface comprises at least one of:
one or more speed controls;
one or more event navigation controls;
one or more priority event navigation controls;
one or more comparison tools; and
one or more scrub bars.

15. The method of claim 1:
wherein one or more of the first events includes either an encrypted user input or a flagged action;
wherein causing the second events to occur in the playback application comprises:
causing a first portion of the first events to occur in the playback application where the first portion of the first events includes the events that occurred before the encrypted user input or the flagged action;
after causing the first portion of the first events to occur in the playback application, refraining from causing a second portion of the first events to occur until first playback unit receives an indication that an equivalent of the encrypted user input or flagged action has occurred on the second client device; and
in response to first playback unit receiving the indication, causing the second portion of the first events to occur in the playback application where the second portion of the first events includes events that occurred after the encrypted user input or the flagged action.

16. A method comprising:
while a capture unit and a monitored application are executing on a first client device, capturing, by the capture unit, first events that occur in the monitored application;
sending, by the capture unit, records of the first events to a sync service executing on a server computer that is remote relative to the first client device;
wherein at least some of the records include first device-specific information that is based on the first client device;
at the sync service, converting the first device-specific information to second device-specific information that is based on a second client device;
generating, by the sync service, playback data for the second client device based on the second device-specific information;
sending, by the sync service, playback data to the second client device;
while a playback unit and a playback application are executing on the second client device, sending, by first playback unit, to the playback application, the playback data; and
wherein sending the playback data to the playback application causes second events, that correspond to at least a subset of the first events, to occur in the playback application.

17. The method of claim 16 wherein converting the first device-specific information to second device-specific information that is based on the second client device comprises:
converting the first device-specific information into device-independent information; and
converting the device independent information into second device-specific information.

18. The method of claim 17:
wherein the first device-specific information includes coordinates on a first display;
wherein converting the first device specific information into device-independent information includes translating the coordinates on the first display to one or more percentages of a display;
wherein converting the device-independent information into device-specific information includes translating the percentages of a display to coordinates of a second display.

19. The method of claim 16 wherein the converting the first device-specific information to second device-specific information that is based on the second client device occurs in response to:
receiving, from the second client device, device capabilities of the second client device;
wherein the device capabilities of the second client device differ from device capabilities of the first client device.

20. The method of claim 19:
wherein the difference in device capabilities between the second client device and the first client device includes first software installed on the first client device that is has not been installed on the second client device;
wherein at least one of the first events that occur in the monitored application uses the first software;
wherein converting the first device-specific information to second device-specific information that is based on the second client device comprises:
accessing a database that includes data on one or more pieces of comparable software that are relatable to the first software;
determining that second software installed on the second client device belongs to the one or more pieces of comparable software;
executing the at least one of the first events that uses the first software using the second software.

21. The method of claim 16 wherein the step of converting the first device-specific information to second device-specific information that is based on the second client device occurs in response to:
receiving, from the second client device, application data of the playback application executing on the second client device;
wherein the playback application executing on the second client device is not the same as the monitored application.

22. The method of claim 21 wherein the converting the first device-specific information to second device-specific information that is based on the second client device comprises:
determining that the playback application executing on the second client device is not the same as the monitored application;
accessing a database that includes data on one or more comparable applications that are relatable to the monitored application and one or more comparable events in the comparable applications that are relatable to one or more events that can occur in the monitored application;
determining that the playback application belongs to the one or more comparable applications; and
replacing the first events in the records of the first events with the one or more comparable events in the playback application that are relatable to the first events.

23. A method comprising:
receiving, on a first computing device, information about events that occurred in each of a plurality of user sessions;
wherein, for each given session, the information includes:
an identification of a user that participated in the given session;
indications of which events occurred during the given session;
timestamps that indicate when events in the given session occurred; and
one or more result scores for the user that participated in the given session;
determining one or more correlations by analyzing the events and the information;
wherein determining one or more correlations includes at least one of:
determining a correlation between result scores in the plurality of sessions and a timing of events in the plurality of sessions; and
determining a correlation between result scores in the plurality of sessions and events that occurred in the plurality of sessions; and
creating recommendations for one or more users based on the one or more correlations;
wherein the method is performed by one or more computing devices.

24. One or more non-transitory storage media storing instructions which, when executed by one or more computing devices, cause performance of a method comprising:
while a capture unit and a monitored application are executing on a first client device, capturing, by the capture unit, first events that occur in the monitored application;
wherein the capture unit is separate from the monitored application and captures the first events through an API of the monitored application;
sending, by the capture unit, records of the first events to a sync service executing on a server computer that is remote relative to the first client device;
generating, by the sync service, playback data based on the records;
sending, by the sync service, playback data to a second client device;
executing a playback unit and a playback application on the second client device;
sending, by first playback unit, to the playback application, the playback data;
wherein first playback unit is separate from the playback application and sends at least a subset of the playback data through an API of the playback application; and
wherein sending the playback data through the API of the playback application causes second events, that correspond to at least a subset of the first events, to occur in the playback application.

25. One or more non-transitory storage media storing instructions which, when executed by one or more computing devices, cause performance of a method comprising:
while a capture unit and a monitored application are executing on a first client device, capturing, by the capture unit, first events that occur in the monitored application;
sending, by the capture unit, records of the first events to a sync service executing on a server computer that is remote relative to the first client device;
wherein at least some of the records include first device-specific information that is based on the first client device;
at the sync service, converting the first device-specific information to second device-specific information that is based on a second client device;
generating, by the sync service, playback data for the second client device based on the second device-specific information;
sending, by the sync service, playback data to the second client device;
while a playback unit and a playback application are executing on the second client device, sending, by first playback unit, to the playback application, the playback data; and
wherein sending the playback data to the playback application causes second events, that correspond to at least a subset of the first events, to occur in the playback application.

26. One or more non-transitory storage media storing instructions which, when executed by one or more computing devices, cause performance of a method comprising:
receiving, on a first computing device, information about events that occurred in each of a plurality of user sessions;
wherein, for each given session, the information includes:
an identification of a user that participated in the given session;
indications of which events occurred during the given session;
timestamps that indicate when events in the given session occurred; and
one or more result scores for the user that participated in the given session;
determining one or more correlations by analyzing the events and the information;
wherein determining one or more correlations includes at least one of:
determining a correlation between result scores in the plurality of sessions and a timing of events in the plurality of sessions; and
determining a correlation between result scores in the plurality of sessions and events that occurred in the plurality of sessions; and
creating recommendations for one or more users based on the one or more correlations.
